(19) United States
(12) Patent Application Publication
(10) Pub. No.: US 2025/0296505 A1
(43) Pub. Date: Sep. 25, 2025

(54) TECHNIQUES FOR ADJUSTING VEHICLE STEP

(71) Applicant: Ford Global Technologies, LLC, Dearborn, MI (US)

(72) Inventors: Vishal Vinayak Nageshkar, Windsor (CA); Scott Nydam, Farmington Hills, MI (US); Sangram Laxman Tamhankar, Farmington Hills, MI (US)

(21) Appl. No.: 18/615,102

(22) Filed: Mar. 25, 2024

(51) Int. Cl. B60R 3/02

(52) U.S. Cl. CPC B60R 3/02

(57) ABSTRACT

The techniques described herein relate to a motor vehicle, including: a cargo area including a floor; a step including a deck; a guide assembly configured to guide movement of the step; a motor configured to move the guide assembly to adjust a position of the step; at least one sensor configured to obtain information indicative of a height of the deck relative to a groundscape adjacent the motor vehicle; and a controller configured to interpret the information from the at least one sensor to determine the height of the deck relative to the groundscape and the floor, and wherein the controller is configured to instruct the motor to adjust the position of the deck to be substantially halfway between the groundscape and the floor.

### TECHNICAL FIELD

This disclosure relates to motor vehicles having a step, and in particular relates to techniques for adjusting the position of the step.

### BACKGROUND

Some motor vehicles, such as vans, include a cargo area. The cargo area is typically accessible via one or more doors near a rear of the vehicle. Such vans are known to include a step near the back bumper to facilitating access to the cargo area, and in particular to assist users in loading and unloading items from the cargo area. Vans with such features are sometimes referred to as “step in” vans, and are often employed for various purposes, including transportation of goods and other commercial or industrial applications.

### SUMMARY

In some aspects, the techniques described herein relate to a motor vehicle, including: a cargo area including a floor; a step including a deck; a guide assembly configured to guide movement of the step; a motor configured to move the guide assembly to adjust a position of the step; at least one sensor configured to obtain information indicative of a height of the deck relative to a groundscape adjacent the motor vehicle; and a controller configured to interpret the information from the at least one sensor to determine the height of the deck relative to the groundscape and the floor, and wherein the controller is configured to instruct the motor to adjust the position of the deck to be substantially halfway between the groundscape and the floor.

In some aspects, the techniques described herein relate to a motor vehicle, wherein the controller is configured such that the controller only instructs the motor to adjust the position of the deck when a height between the groundscape and the floor exceeds a predefined threshold.

In some aspects, the techniques described herein relate to a motor vehicle, wherein the groundscape adjacent the vehicle is a groundscape directly beneath the step.

In some aspects, the techniques described herein relate to a motor vehicle, wherein the groundscape adjacent the vehicle is beneath the step and rearward of the step.

In some aspects, the techniques described herein relate to a motor vehicle, wherein the guide assembly is configured to guide movement of the step vertically without the step also moving in a forward or a rearward direction.

In some aspects, the techniques described herein relate to a motor vehicle, wherein the guide assembly is configured to guide movement of the step such that as the step is lowered, the step moves rearwardly as the step moves vertically, and such that as the step is raised, the step moves forwardly as the step moves vertically.

In some aspects, the techniques described herein relate to a motor vehicle, wherein the at least one sensor includes a first sensor mounted to an underside of the step, and a second sensor mounted to an underbody of the motor vehicle adjacent the step.

In some aspects, the techniques described herein relate to a motor vehicle, wherein the first and second sensors are range sensors.

In some aspects, the techniques described herein relate to a motor vehicle, wherein the at least one sensor includes a depth perception sensor.

In some aspects, the techniques described herein relate to a motor vehicle, wherein the at least one sensor includes at least one of a color camera, a time of flight sensor, near infrared sensor, and a range sensor.

In some aspects, the techniques described herein relate to a motor vehicle, wherein the at least one sensor includes at least a color camera and a time of flight sensor.

In some aspects, the techniques described herein relate to a motor vehicle, wherein the color camera and time of flight sensor are integrated into a single sensor assembly.

In some aspects, the techniques described herein relate to a motor vehicle, wherein the single sensor assembly is mounted adjacent a top of the motor vehicle and adjacent an access point for the cargo area such that the single sensor assembly has the floor, the deck, and the groundscape in a field of view of the single sensor assembly.

In some aspects, the techniques described herein relate to a motor vehicle, wherein the motor vehicle is a van.

In some aspects, the techniques described herein relate to a motor vehicle, wherein the van includes a door adjacent a rear of the van, and wherein the door is configured to open to permit access to the cargo area.

In some aspects, the techniques described herein relate to a motor vehicle, wherein the step is adjacent the rear of the van.

In some aspects, the techniques described herein relate to a motor vehicle, wherein the step provides a rear bumper of the van.

In some aspects, the techniques described herein relate to a motor vehicle, wherein the van includes a rear bumper independent of the step.

In some aspects, the techniques described herein relate to a method, including: lowering a step of a motor vehicle such that a deck of the step is substantially halfway between a floor of a cargo area of the motor vehicle and a groundscape adjacent the motor vehicle.

In some aspects, the techniques described herein relate to a method, wherein the step is only lowered when a height between the groundscape and the floor exceeds a predefined threshold.

### BRIEF DESCRIPTION OF THE DRAWINGS

FIG. 1 is a rear perspective view of an example motor vehicle. In FIG. 1, a step is in a deployed position.

FIG. 2 is a rear perspective view of the motor vehicle of FIG. 1, with rear doors open.

FIG. 3 is a view of an example arrangement of a motor and guide assembly relative to the step.

FIG. 4 is a somewhat schematic view representative of a first technique for adjusting the step.

FIG. 5 is a somewhat schematic view representative of another example guide assembly and an optional handle.

FIG. 6 is a field of view of a sensor arranged adjacent a top of the motor vehicle, and is representative of a second technique for adjusting the step.

FIG. 7 is a somewhat schematic view of an example technique for adjusting the step when the groundscape is substantially flat.

FIG. 8 is a somewhat schematic view of an example technique for adjusting the step when the groundscape includes an object such as a curb near the step.

FIG. 9 is a somewhat schematic view of an example technique when the groundscape includes an object such as a loading dock adjacent the step.

### DETAILED DESCRIPTION

This disclosure relates to motor vehicles having a step, and in particular relates to techniques for adjusting the position of the step. Among other benefits, this disclosure sets a position of a step at a convenient height for a user, and in particular sets the position of the step at a height that accounts for the relative position of the floor of the cargo area and the adjacent groundscape. Specifically, this disclosure provides even step heights between the groundscape, step, and floor. Further, the disclosure sets the step height automatically, requiring minimal to no user intervention.

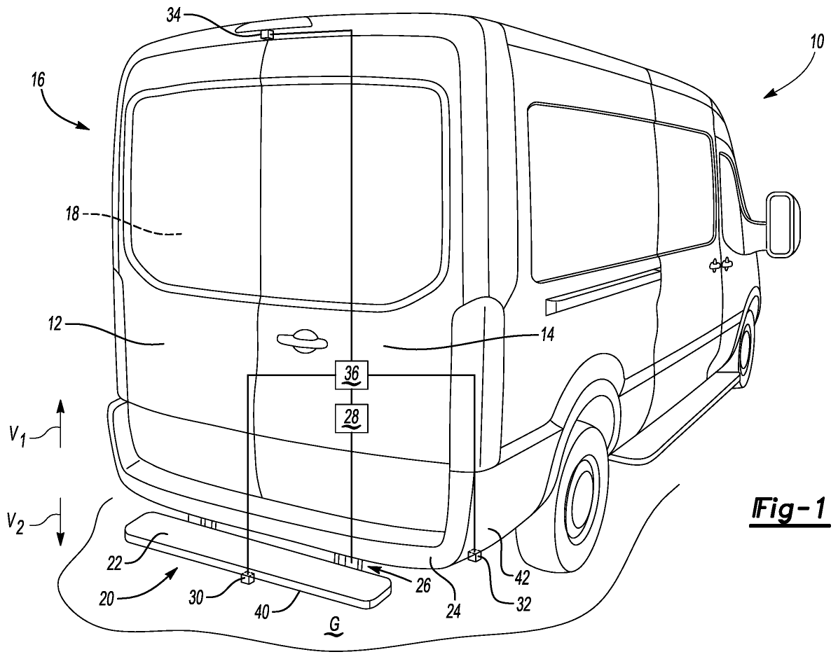

Referring to the drawings, FIG. 1 is a rear-perspective view of a motor vehicle 10 (“vehicle 10”). The vehicle 10 in this example is a van. The vehicle 10 includes two doors 12, 14 adjacent a rear 16 of the vehicle 10 configured to open and close to selectively permit access to, and enclose, respectively, a cargo area 18 from the rear. While a van is pictured, this disclosure is also applicable to other types of vehicles, such as trucks, buses, etc.

The vehicle 10 includes a step 20. The step 20 includes a deck 22, which provides an upper surface upon which a user can place their feet when stepping into or out of the cargo area 18. The deck 22 may include ridges, ribs, or other friction features to increase traction relative to a foot, or footwear, of a user. As will be discussed in more detail below, the step 20 is configured to be raised in a vertically upward direction V₁ and lowered in a vertically downward direction V₂ relative to a groundscape G adjacent the vehicle 10.

Groundscape G, in this disclosure, refers to both naturally occurring ground surfaces, such as rock, grass, dirt, etc., as well as constructed elements that are generally on or near the naturally occurring ground surface, including concrete, curbs, steps, loading docks, etc.

In the embodiment of FIG. 1, the step 20 is independent of a rear bumper 24 of the vehicle 10. In particular, the step 20 is spaced-apart from the rear bumper 24 such that vertical movement of the step 20 will not interfere with the rear bumper 24. In other examples, the step 20 is integrated into, and provides, a rear bumper of the vehicle 10. In those examples, the rear bumper is moveable vertically together with movement of the step 20.

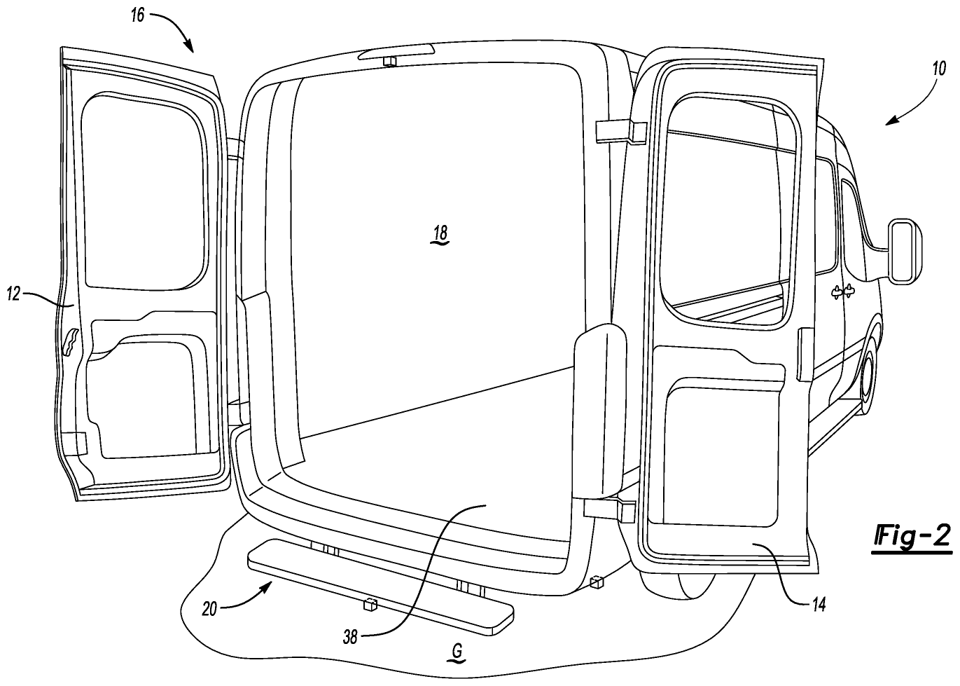

The vehicle 10 includes a guide assembly 26 configured to guide movement of the step 20, and a motor 28 configured to move the guide assembly 26 to adjust a position of the step 20. The vehicle 10 further includes at least one sensor. Each of the at least one sensors may be an assembly including a plurality of sensors. In FIG. 1, the vehicle 10 is shown with three sensors 30, 32, 34. A controller 36 is configured to interpret signals and information from the at least one sensor to determine the height of the deck 22 relative to the groundscape G and to determine the height of the deck 22 relative to a floor 38 (FIG. 2) of the cargo area 18. The floor 38 is the bottom surface of the cargo 18, and in particular is the floor surface the user first touches when stepping into the cargo area 18, or last touches when leaving the cargo area 18.

In this disclosure, the controller 36 is configured to instruct the motor 28 to adjust the position of the deck 22 to be substantially halfway between the groundscape G and the floor 38. Doing so provides even step heights for a user between the groundscape G and the floor 38. The techniques for adjusting the position of the step 20, and specifically the deck 22, will be discussed below.

The controller 36 is shown schematically in FIG. 1. It should be understood that the controller 36 could be part of an overall vehicle control module, such as a vehicle system controller (VSC), or could alternatively be a stand-alone controller separate from the VSC. Further, the controller 36 may be programmed with executable instructions for interfacing with and operating the various components of the vehicle 10. The controller 36 may be operable in response to signals from a key fob, a vehicle infotainment system, or a mobile device of a user, for example. The controller 36 additionally includes a processing unit and non-transitory memory for executing the various control strategies and modes of the vehicle system.

In one example, the motor 28 is an electric motor, and is responsive to instructions from the controller 36 to selectively adjust a position of the guide assembly 26, and in turn the step 20 and the deck 22. While one motor 28 is shown, additional motors could be provided.

With respect to the sensors 30, 32, 34, each sensor is shown in an exemplary location. In particular, in the embodiment of FIG. 1, the sensor 30 is mounted to an underside 40 of the step 20. The sensor 32 is mounted to an underbody of the vehicle 10. Further, the sensor 34 is mounted adjacent a top of the vehicle 10 and adjacent an access point to the cargo area 18, namely adjacent a rear opening in the vehicle 10. The sensor 34 could be incorporated into a center high-mounted stop lamp (CHMSL) or a rear back-up camera of the vehicle 10. While three sensors 30, 32, 34 are shown, this disclosure extends to vehicles having a different number of sensors.

In a particular aspect of this disclosure, sensors 30, 32 are ranging sensors. Specifically, sensors 30, 32 are either a light detection and ranging (LIDAR) sensors or radio detecting and imaging (RADAR) sensors. The sensor 34, in this example, is a depth perception sensor. Specifically, the sensor 34 is a sensor assembly including at least a color camera and a time of flight sensor. The sensor 34 may include a color camera, a time of flight sensor, and a near-infrared (NIR) sensor in a single assembly, in one embodiment. When the sensor includes a time of flight sensor, a color hue scale may be used, and each color is associated with a unique code, which may be alphanumeric, and can be interpreted by the controller 36 as corresponding to a height.

Each of the sensors 30, 32, 34 could be provided by one or more color cameras, RADAR sensors, LIDAR sensors, ultrasonic sensors, or near-infrared (NIR) sensors, as examples. It should be understood that this disclosure extends to vehicles that have different sensor systems. For example, as discussed below, in one embodiment the vehicle 10 includes sensors 30 and 32, but not sensor 34. In another embodiment, the vehicle 10 includes sensor 34 but not sensors 30 or 32.

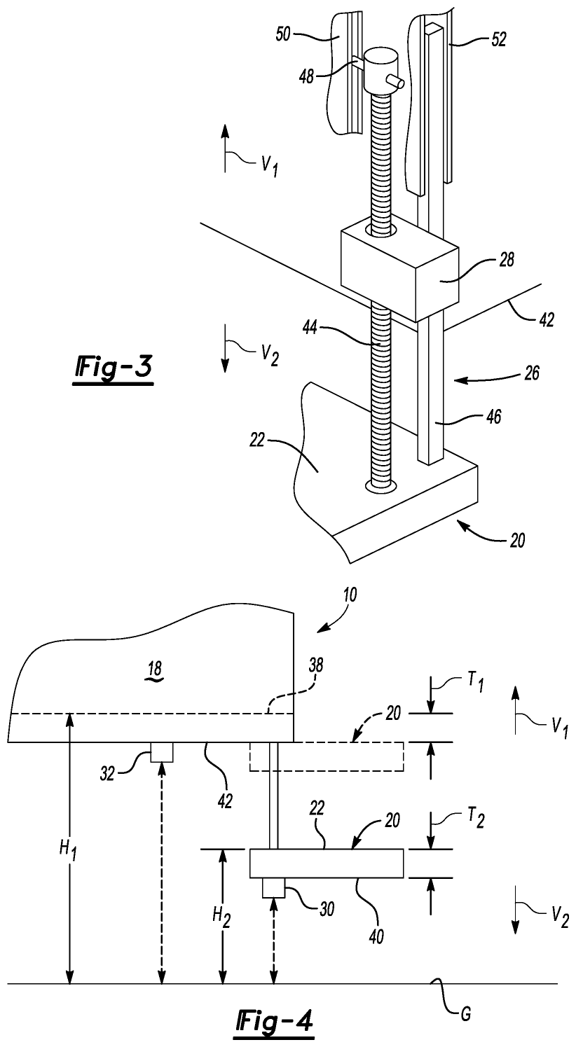

With reference to FIG. 3, an example configuration of the guide assembly 26 and motor 28 is shown relative to the step 20. In particular, the guide assembly 26 includes a spindle 44 and a support rail 46. Both the spindle 44 and the support rail 46 are coupled to the step 20 at respective bottom ends thereof. Rotation of the motor 28 causes the spindle to move vertically in direction V₁ or V₂. At an end opposite the step 20, the spindle 44 includes a pin 48 configured to slide within track 50. The arrangement of the pin 48 and track 50 provides stability to the spindle 44. The step 20 and pin 48 are connected to the spindle 44 such that the step 20 and pin 48 do not rotate with the spindle 44. Further, opposite the step 20, the support rail 46 is configured to slide within a guide 52 for stability. The motor 28 does not directly interface with the support rail 46, in this example. The support rail 46 is configured to stabilize and support the step 20. The support rail 46 may include a non-rounded cross-section, such as a square-cross section, configured to substantially match a cross-section of the guide 52 to prevent rotation of the step 20.

The configuration of elements in FIG. 3 is exemplary only. This disclosure extends to other arrangements of the guide assembly 26 and motor 28 relative to the step 20. In FIG. 3, the guide assembly 26 and motor 28 may be within an interior of the vehicle 10. In a particular example, only a bottom portion of the spindle 44 and support rail 46 project outside the vehicle 10.

It should be understood that the vehicle 10 may include another, substantially identical, arrangement of the guide assembly 26 and motor 28 on an opposite side of the centerline of the vehicle 10, in one example. Specifically, the opposite side of the vehicle 10 may include a guide assembly 26 and motor 28, for a total of two guide assemblies and motors on the vehicle 10 that are configured to selectively raise and lower the step 20. In that example, each motor 28 is responsive to instructions from controller 36.

In yet another example, there may be only one powered guide assembly configured to actively move the step 20. Specifically, the vehicle 10 may include a guide assembly 26 and motor 28 arranged as shown in FIG. 3 adjacent one side of the step 20, and adjacent the other side of the step 20 there may be a non-powered guide assembly including a support rail similar to support rail 46, for example, and configured to guide the movement of the step 20 without being directly powered by a motor.

An example technique for adjusting the position of the step 20 will now be described relative to FIG. 4. FIG. 4 schematically illustrates the vehicle 10 in a configuration in which the vehicle 10 includes sensors 30 and 32, but not sensor 34. Again, sensor 30 is mounted to an underside 40 of the step 20, and sensor 32 is mounted to an underbody 42 of the vehicle 10. The sensors 30, 32 are ranging sensors in this embodiment.

During use of the vehicle 10 in which the vehicle 10 is moving, the step 20 is held in a stowed position, as generally shown in phantom in FIG. 4. The stowed position is adjacent the rear bumper, in an example, and is a highest vertical position of the step 20.

When the vehicle 10 is stationary and in park, in an example, the controller 36 is configured to interpret signals from the sensors 30, 32 to determine a height H₁ of the floor 38 relative to the groundscape G. If the height H₁ exceeds a predefined threshold height, the controller 36 instructs the motor 28 to move the guide assembly 26 to lower the step 20 from the stowed position to a deployed position in which the deck 22 is at a height H₂ above the groundscape G. The height H₂ is substantially half the height H₁. Substantially half, in this disclosure, means half, within an industry-accepted tolerance. The heights H₁ and H₂ are measured in a direction perpendicular to the groundscape G. In this example, the sensors 30, 32 are configured to sense the relative position of the step 20 and underbody 42, respectively, relative to the groundscape G directly underneath the respective sensors 30, 32.

In an aspect of this disclosure, the controller 36 is programmed with the vertical dimensions, or thicknesses, between the underbody 42 and the floor 38, which is labeled as T₁ in FIG. 4, and between the underside 40 and the deck 22, labeled as T₂. The controller 36 is able to account for these thicknesses T₁, T₂ when interpreting signals from sensors 30, 32 as heights H₁, H₂.

When determining the height H₂, in one embodiment, the controller 36 uses the uppermost surface of the deck 22. In another embodiment, the controller 36 uses the uppermost, substantially flat surface of the deck 22, omitting any friction features such as ridges or ribs.

Using the signals from the sensors 30, 32, the controller 36 instructs the motor 28 to move the guide assembly 26 so as to lower the step 20 until the deck 22 is at height H₂. When the step 20 is no longer needed, the controller 36 instructs the motor 28 to move the guide assembly 26 so as to raise the step 20 back to the stowed position.

In an aspect of this disclosure, the vehicle 10 is configured to move the step 20 to the deployed position automatically, requiring minimal or no user intervention. In one specific aspect of this disclosure, the controller 36 may be programmed to automatically move the step from a stowed position to a deployed position every time the vehicle 10 is stationary and in park. This aspect of the disclosure may be useful with deliveries in which a user is making frequent stops and is frequently needing to enter and exit the cargo area 18. In another aspect, the controller 36 may deploy the step 20 in response to another type of signal. The signal may be initiated by a user request, such as by a user pressing a button in the cargo area 18 or a passenger cabin of the vehicle 10. Despite the user pressing a button, the user involvement is minimal, and the process of deploying the step 20 is still considered automatic in this disclosure. The controller 36 could alternatively be configured to deploy the step 20 when a user is detected in the cargo area 18 or near a rear of the vehicle 10.

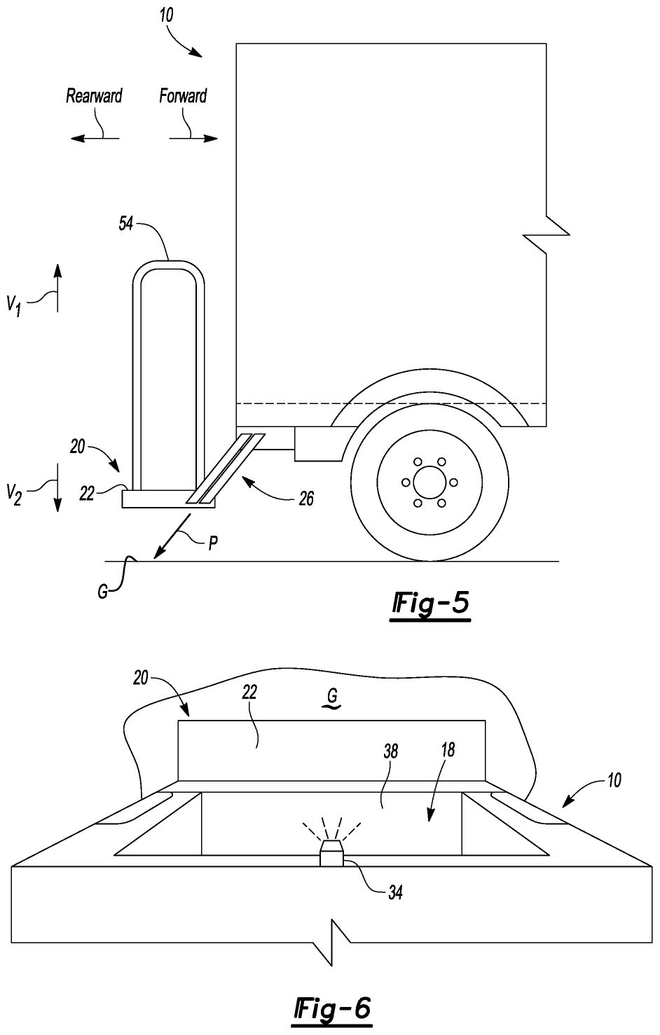

While in FIGS. 1-4 the step 20 is shown as moving substantially vertically without also moving either forwardly or rearwardly, the guide assembly 26 could be configured to permit such movements. In an example, in FIG. 5, the guide assembly 26 is configured such that the step follows a path P which is non-perpendicular relative to groundscape G. Specifically, in FIG. 5, the guide assembly 26 is configured to guide movement of the step 20 such that as the step is lowered, the step moves rearwardly (the “rearward” direction is labeled in FIG. 5) as the step 20 moves in direction V₁, and such that as the step 20 is raised, the step moves forwardly (the “forward” direction is labeled in FIG. 5) as the step moves in direction V₂.

FIG. 5 also illustrates an optional handle 54 that can project upward from the deck 22 for use by a user as the user enters and exits the vehicle 10. The handle 54 is not required in all examples. The step 20 could include multiple handles.

Another example technique for adjusting the step 20 will now be described relative to FIG. 6. In FIG. 6, the vehicle 10 is in a configuration in which the vehicle 10 includes sensor 34, but not sensors 30 or 32. Again, sensor 34 is mounted adjacent a top of the vehicle 10 and adjacent an access point of the cargo area 18. The sensor 34 is a depth perception sensor.

FIG. 6 is representative of a field of view of sensor 34. As shown, the sensor 34 is oriented such that the floor 38, deck 22, and groundscape G are all in the field of view of the sensor 34. The sensor 34 is configured to generate signals that can be interpreted by the controller 36 to determine the relative heights of the floor 38, deck 22, and the groundscape G. When the vehicle 10 is stationary and in park, the controller 36 uses the signals from the sensor 34 and instructs the motor 28 to move the guide assembly 26 so as to lower the step 20 until the deck 22 is at height H₂.

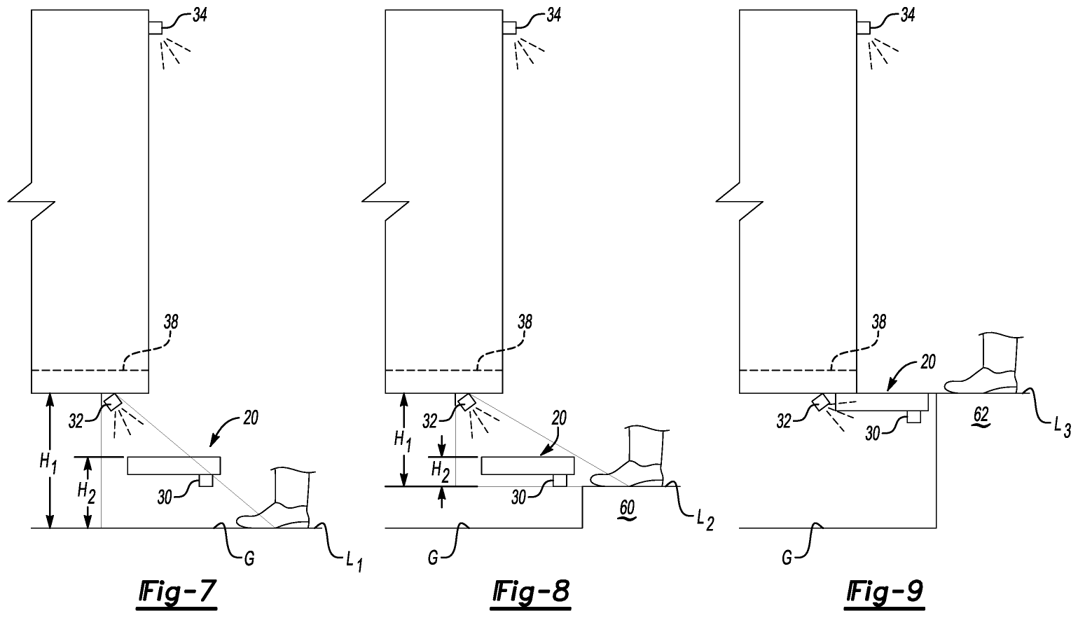

The sensors 30, 32, and/or 34 of the vehicle 10 are configured to generate signals indicative of the heights H₁, H₂ relative to the groundscape G immediately underneath the respective vehicle 10 and step 20. The sensors 30, 32, and/or 34 are also, in one embodiment of this disclosure, configured to detect are configured to generate signals indicative of the heights H₁, H₂ relative to the groundscape G beneath the step 20 and rearward of the step 20. In FIG. 7, for example, sensor 32 is inclined such that the sensor 32 can determine the height H₁ relative to groundscape G at location L₁ rearward of the step 20. Sensors 30 and/or 34 could alternatively or additionally determine the height of the groundscape at location L₁. In this example, the groundscape G is substantially flat, and therefore the step 20 will be deployed to height H₂ halfway between the groundscape G and the floor 38. In another embodiment, an object such as curb 60 is detected at location L₂ rearward of step 20 in FIG. 8. In this example, the groundscape G is raised at location L₂ because of the curb 60. In this example, the height H₁ is set using the vertical distance between the floor 38 and location L₂. The height H₂ is half H₁, and provides the user with an even step height between the curb 60 and the floor 38.

In an aspect of this disclosure, when the height H₁ does not exceed a predefined threshold, the step 20 will not deploy, because, for example, the step 20 is not needed. In an example, an object such as a loading dock 62 is detected at location L₃ rearward of step 20 in FIG. 9. In this example, the groundscape G is raised at location L₃ such that the loading dock 62 is substantially at an even height with the floor 38. In this example, there is no height differential, or a minimal height differential, between the floor 38 and the loading dock 62. Therefore, the predefined threshold has not been exceeded, and the controller 36 will not deploy the step.

It should be understood that terms such as “about,” “substantially,” and “generally” are not intended to be boundaryless terms, and should be interpreted consistent with the way one skilled in the art would interpret those terms. Further, directional terms such as “forward,” “rearward,” “upward,” “downward,” “vertical,” “horizontal,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a cargo area including a floor;
a step including a deck;
a guide assembly configured to guide movement of the step;
a motor configured to move the guide assembly to adjust a position of the step;
at least one sensor configured to obtain information indicative of a height of the deck relative to a groundscape adjacent the motor vehicle; and
a controller configured to interpret the information from the at least one sensor to determine the height of the deck relative to the groundscape and the floor, and wherein the controller is configured to instruct the motor to adjust the position of the deck to be substantially halfway between the groundscape and the floor.

2. The motor vehicle as recited in claim 1, wherein the controller is configured such that the controller only instructs the motor to adjust the position of the deck when a height between the groundscape and the floor exceeds a predefined threshold.

3. The motor vehicle as recited in claim 1, wherein the groundscape adjacent the vehicle is a groundscape directly beneath the step.

4. The motor vehicle as recited in claim 1, wherein the groundscape adjacent the vehicle is beneath the step and rearward of the step.

5. The motor vehicle as recited in claim 1, wherein the guide assembly is configured to guide movement of the step vertically without the step also moving in a forward or a rearward direction.

6. The motor vehicle as recited in claim 1, wherein the guide assembly is configured to guide movement of the step such that as the step is lowered, the step moves rearwardly as the step moves vertically, and such that as the step is raised, the step moves forwardly as the step moves vertically.

7. The motor vehicle as recited in claim 1, wherein the at least one sensor includes a first sensor mounted to an underside of the step, and a second sensor mounted to an underbody of the motor vehicle adjacent the step.

8. The motor vehicle as recited in claim 7, wherein the first and second sensors are range sensors.

9. The motor vehicle as recited in claim 1, wherein the at least one sensor includes a depth perception sensor.

10. The motor vehicle as recited in claim 9, wherein the at least one sensor includes at least one of a color camera, a time of flight sensor, near infrared sensor, and a range sensor.

11. The motor vehicle as recited in claim 10, wherein the at least one sensor includes at least a color camera and a time of flight sensor.

12. The motor vehicle as recited in claim 11, wherein the color camera and time of flight sensor are integrated into a single sensor assembly.

13. The motor vehicle as recited in claim 12, wherein the single sensor assembly is mounted adjacent a top of the motor vehicle and adjacent an access point for the cargo area such that the single sensor assembly has the floor, the deck, and the groundscape in a field of view of the single sensor assembly.

14. The motor vehicle as recited in claim 1, wherein the motor vehicle is a van.

15. The motor vehicle as recited in claim 14, wherein the van includes a door adjacent a rear of the van, and wherein the door is configured to open to permit access to the cargo area.

16. The motor vehicle as recited in claim 15, wherein the step is adjacent the rear of the van.

17. The motor vehicle as recited in claim 16, wherein the step provides a rear bumper of the van.

18. The motor vehicle as recited in claim 16, wherein the van includes a rear bumper independent of the step.

19. A method, comprising:
lowering a step of a motor vehicle such that a deck of the step is substantially halfway between a floor of a cargo area of the motor vehicle and a groundscape adjacent the motor vehicle.

20. The method as recited in claim 19, wherein the step is only lowered when a height between the groundscape and the floor exceeds a predefined threshold.
